(19) United States
(12) Patent Application Publication
(10) Pub. No.: US 2006/0000810 A1
(43) Pub. Date: Jan. 5, 2006

(54) Method of and system for dynamic laser welding

(76) Inventors: James A. Kerr, Lexington, KY (US); Tim Frasure, Georgetown, KY (US); David Thomas Shadwick, Wilmore, KY (US); Jon Brock Whitney, Georgetown, KY (US)

Correspondence Address: JAMES H BEUSSE;HOLLAND & KNIGHT, P O BOX 1526, ORLANDO, FL, 328020633, US

(21) Appl. No.: 10/883,250

(22) Filed: Jun. 30, 2004

(51) Int. Cl. B23K 1/00

(52) U.S. Cl. 219/85.13

(57) ABSTRACT

A method of welding a first material of an apparatus to a second, semi-crystalline material of the apparatus. The method includes the acts of heating a weld area with a first power intensity for one time period and heating the weld area with a second power intensity (not equivalent to the first power intensity) for another time period. The method also includes applying pressure to the weld area and producing a collapse distance within at least a portion of the weld area.

### BACKGROUND OF THE INVENTION

The present invention generally relates to power profile control for welding and in one arrangement, more particularly, to power profile control for welding inkjet printheads.

Generally, laser welding attaches a generally optically transparent or translucent material to a generally energy absorbing material using the standard constant power profile 300 illustrated in FIG. 11. The process begins with the two materials being held together. In one arrangement, the generally optically transparent material is positioned over the generally energy absorbing material. Laser light is passed at constant power intensity through the transparent material and absorbed by the absorbing material. As shown in FIG. 11, the constant power is usually set at a percentage (e.g., 65%) of the maximum power intensity that the materials can receive.

In some arrangements, laser light is applied to the weld area in a contour welding method. Contour welding applies the beam of laser light on a single point of the weld area and welds the materials of the weld area point by point. For example, the laser beam can maneuver around the weld area, or the weld area can maneuver around the laser beam. In other arrangements, the laser light is applied to the weld area in a semi-simultaneous welding method or a simultaneous welding method. Semi-simultaneous welding method and simultaneous welding methods heat and weld multiple points of the weld area at the same time.

The laser energy is generally absorbed in a very thin portion of the absorbing material near the surface. Heat is conducted to the transparent material and also further conducted to the absorbing material from the surface in order to soften enough material to create a good joint. The laser power is normally ended by a preset timer or by the equipment sensing a preset collapse distance of the welded materials.

### SUMMARY OF THE INVENTION

Various material combinations have been successfully attached using laser welding. However, one of the issues occurring when welding a semi-crystalline material is that the material has a very narrow sealing and softening temperature range. Accordingly, semi-crystalline materials are more prone to overheating and to developing imperfections (e.g., bubbles) in the weld joint.

Typically, the standard constant power profile being used during the simultaneous weld cycle for semi-crystalline materials produces bubbles in the weld area and effects the reliability of the weld joint. A dynamic power profile used during the weld cycle can, in some arrangements, allow the semi-crystalline material to quickly heat to a desired temperature and then maintain that temperature in a more controlled fashion to produce reliable weld joints.

In other arrangements, the dynamic power profile can reduce the welding time of non semi-crystalline materials.

In several embodiments, the invention provides a dynamic power profile for a laser weld cycle. The dynamic power profile can be used to weld a first portion to a second portion that includes a semi-crystalline material. For example, the dynamic power profile can be used to weld a printhead lid to a semi-crystalline printhead body.

In one embodiment, the invention provides a method of welding a first material of an apparatus to a second, semi-crystalline material of the apparatus. The method includes the acts of heating a weld area with a first power intensity for one time period and heating the weld area with a second power intensity (not equivalent to the first power intensity) for a second time period. The weld area is also not heated using a contour welding method.

In another embodiment, the invention provides a method of welding a first material of an apparatus to a second material of an apparatus. The method includes the acts of heating a weld area with a first power intensity for one time period, receiving feedback regarding the weld area during the one time period, and heating the weld area with a second power intensity for another time period based at least in part on the received feedback. The second power intensity is not equal to the first power intensity.

In still another embodiment, the invention provides a laser welding assembly for welding a first material of an apparatus to a second material of the apparatus during a weld cycle. The assembly includes a laser source for producing a light beam operable to heat at least a portion of the weld area. The light beam has a power intensity, and the laser source includes a source input terminal. The assembly also includes a controller having an input terminal operable to receive a first signal, and an output terminal coupled to the source input terminal and operable to transmit a second signal. The second signal includes a command to vary the power intensity of the light beam during a weld cycle, and the command is based at least in part on the first signal.

In still another embodiment, the invention provides a method of welding a first material of an apparatus to a second, semi-crystalline material of the apparatus. The method includes the acts of heating a weld area with a first power intensity for one time period and heating the weld area with a second power intensity (not equivalent to the first power intensity) for a second time period. The method also includes applying pressure to the weld area and producing a collapse distance within a portion of the weld area.

### BRIEF DESCRIPTION OF THE DRAWINGS

FIG. 1 is a perspective view of an inkjet printhead.

FIG. 2 is an exploded perspective view of a portion of an inkjet printhead, such as the inkjet printhead shown in FIG. 1.

FIG. 3 is a perspective view of a portion of an inkjet printhead, such as the inkjet printhead shown in FIG. 1.

FIG. 4 is a perspective view of a laser welding assembly.

FIG. 5 is a perspective view of another laser welding assembly.

FIG. 6 is a graph illustrating a first welding profile for use with a laser welding assembly, such as one of the laser welding assemblies shown in FIGS. 4 and 5.

FIG. 7 is a graph illustrating a welding profile for use with a laser welding assembly, such as one of the laser welding assemblies shown in FIGS. 4 and 5.

FIG. 8 is a graph illustrating another welding profile for use with a laser welding assembly, such as one of the laser welding assemblies shown in FIGS. 4 and 5.

FIG. 9 is a graph illustrating still another welding profile for use with a laser welding assembly, such as one of the laser welding assemblies shown in FIGS. 4 and 5.

FIG. 10 is a graph illustrating collapse of a material given over time during a welding profile.

FIG. 11 is a graph illustrating a prior art welding profile for use with a prior art laser welding assembly.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings.

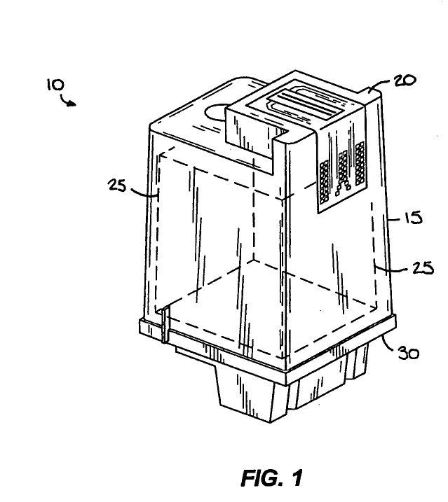

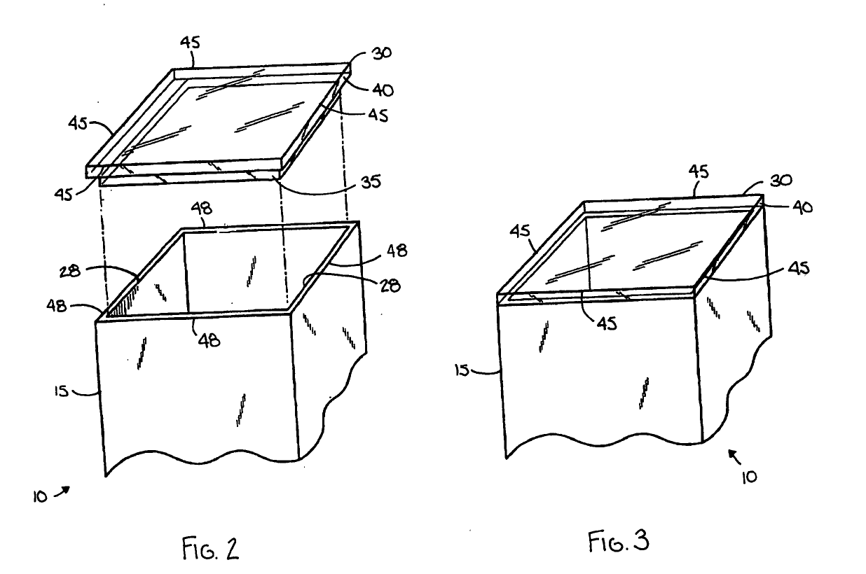

FIGS. 1-3 illustrate at least a portion of an inkjet printhead 10 which is assembled using a dynamic power profile during laser welding. The printhead 10 includes a housing or body 15 that defines a nosepiece 20 and at least partially defines an ink reservoir 25. The body 15 further defines an opening 28, as shown in FIG. 2.

The body 15 can be constructed of a variety of materials including, without limitation, at least one of polymers, metals, ceramics, composites and the like. In the illustrated embodiments, the body 15 is constructed of at least one semi-crystalline material. For example, the body 15 can be constructed from glass-filled polybutylene terephthalate resin (available from G. E. Plastics of Huntersville, N.C. under the trade name VALOAX).

The printhead 10 further includes a lid 30 that is welded to the body 15 to cover the ink reservoir 25. When the lid 30 is welded to the housing 12, the lid 30 and housing 12 form a seal to prevent leakage of ink from the ink reservoir 25.

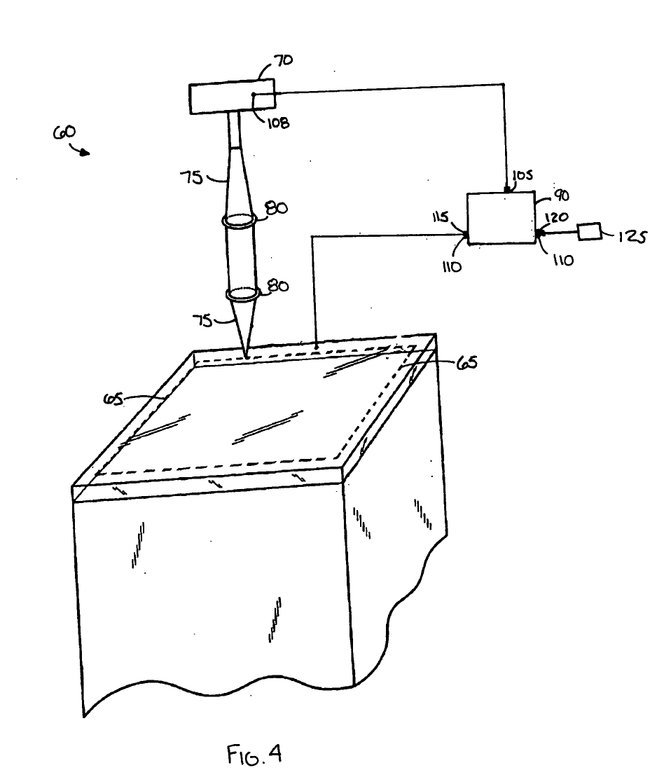

In the illustrated embodiments of FIGS. 2 and 3, the lid 30 includes a first portion 40 configured have a perimeter 45 approximately the same size as the perimeter 48 (shown in FIG. 2) of the printhead body 15. At least a portion of the lid 30, such as, for example, an area of the first portion 40, is constructed of a generally optically transparent or translucent material. In the illustrated embodiment, the entire first portion 40 of the lid 30 is constructed of a generally optically transparent or translucent material.

In another embodiment, such as the embodiment illustrated in FIG. 3, the lid 30 can also include a second portion 35 that substantially fits within the opening 28 defined by the printhead body 15. In this illustrated embodiment, the second portion 35 is coupled to the first portion 40. As shown in FIG. 2, the lid 30 may not include the second portion 35. In other embodiments, the second portion 35 of the lid 35 can also be constructed of a generally optically transparent or translucent material.

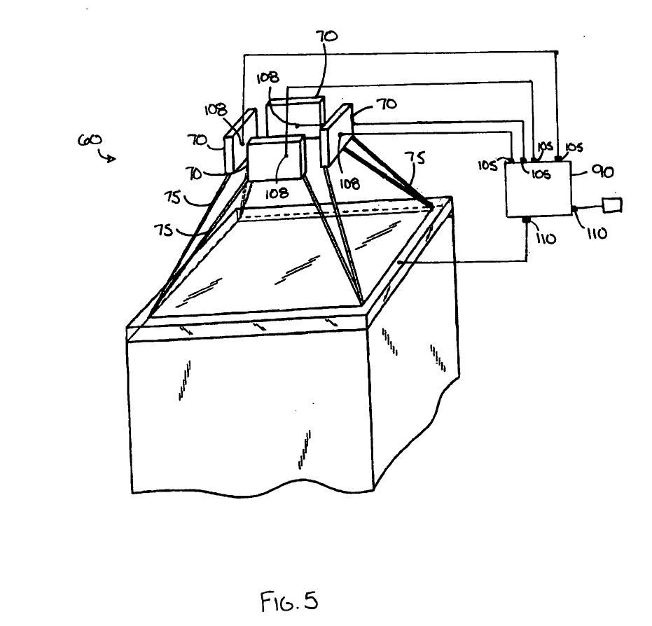

FIGS. 4 and 5 illustrate exemplary laser welding assemblies 60 for heating the weld joint or area 65 (shown in dashed lines) of a printhead 10. The laser welding assembly 60 illustrated in FIG. 4 includes a single laser source 70 producing a beam of light 75. The laser welding assembly 60 illustrated in FIG. 5 includes a plurality of laser sources 70, each producing a laser beam 75. In other embodiments, the laser welding assembly 60 can include more or fewer laser sources 70 than shown and described.

In some embodiments, such as the embodiment illustrated in FIG. 4, the assembly 60 may also include one or more manipulating elements 80 that can manipulate (e.g., control, focus, redirect, converge, diverge, split, scatter and the like, for example) the beam 75. The manipulating elements 80 can include, for example, one or more lens, one or more fiber optic cables, one or more wave guides, one or more mirrors, one or more masks, and the like, or a combination of these and/or similar elements. In further embodiments, the manipulating elements 80 can further be used to apply pressure to the weld area 65 during the welding cycle. For example, a manipulating element 80, such as a waveguide, can apply pressure to the weld area 65 to produce a certain collapse distance, as discussed below.

In the illustrated embodiment of FIG. 4, the manipulating elements 80 each include a lens. The assembly 60 illustrated in FIG. 4 is a contour system as is known in the art. In another embodiment, the assembly 60 can include one or more manipulating elements 80, such as, for example, a user-programmed mirror, to circle the beam 75 rapidly around the weld area 65, thereby establishing a semi-simultaneous system. In a further embodiment, the assembly 60 can include one or more manipulating elements 80, such as, for example, one or more fiber optic cables or a metal mask, that can heat the entire weld area 65 at the same time, thereby establishing a simultaneous system. In the illustrated embodiment of FIG. 5, the assembly 60 is also a simultaneous system through the use of multiple lasers 70 that heat the entire weld area 65 at the same time.

As shown in FIGS. 4 and 5, the assembly 60 also includes a controller 90 operable to control the power intensity, as well as the position, of the laser(s) 70 and any manipulating element(s) 80, for example. In these illustrated embodiments, the controller 90 provides a signal to the laser(s) 70 to modify the power intensity of the light beam 75 of each laser 70 during the weld cycle. In the illustrated embodiment of FIG. 4, the controller includes at least one output terminal 105. In the illustrated embodiment of FIG. 5, the controller 90 includes a plurality of output terminals 105, one dedicated output terminal 105 for each corresponding laser 70. As shown, the output terminal 105 is connected to the laser 70 via a laser input terminal 108. The controller 90 can output a control signal or command to the laser 70 via the output terminal 105 (and the connection between the laser source 70 and the controller 90). In some embodiments, the controller 90 can transmit one command signal to the laser(s) 70 throughout the duration of the weld cycle, or can transmit a plurality of command signals to the laser(s) 70 throughout the duration of the weld cycle.

In some embodiments, the controller 90 can accompany the laser source 70 in a single apparatus, or can be an external controller 90 from the laser 70, such as, for example, a personal computer. In the illustrated embodiment of FIG. 5, for example, the controller 90 can be external to the plurality of lasers 70 or can be included in a single apparatus with at least one laser 70.

In some embodiments, the controller 90 can also include one or more input terminals 110 for receiving various inputs or signals. In some embodiments, such as the embodiment illustrated in FIG. 4, the controller 90 can include a first input terminal 115 for receiving feedback information during the weld cycle. For example, the controller 90 can receive feedback information regarding the weld area 65, such as collapse distance (e.g., distance of one material or area that is collapsing) at any given point of the weld area 65, maximum collapse distance of a portion or throughout the weld area 65, average collapse distance of a portion or throughout the weld area 65, collapse velocity (e.g., how fast the material or area is collapsing), maximum collapse velocity, average collapse velocity, temperature at any given point of the weld area 65, maximum temperature of a portion of or throughout the weld area 65, average temperature of a portion of or throughout the weld area 65, rate of temperature change, maximum rate of temperature change, average rate of temperature change, uniformity of temperature throughout the weld area 65 and temperature deviation of a portion or throughout the weld area 65. In some embodiments, the feedback information received from the input terminal(s) 110 can be used to modify the power intensity of the laser 70 during the weld cycle, as discussed below. In some embodiments, the controller 90 may or may not collect feedback information and may or may not include the input terminal(s) 110.

Also, in some embodiments, such as the embodiment illustrated in FIG. 4, the controller 90 can include a second input terminal 120 for receiving secondary information 125 from outside the weld area 65 during that particular weld cycle. For example, the controller 90 can receive a program or pre-set power profile to be used throughout a weld cycle. In some embodiments, the pre-set power profile can be created by a user through a software program included in the controller 90 or included in an external device. In other embodiments, the secondary information 125 can include information about a different weld area (not shown) from a previous weld cycle, information averaged over various different weld areas from various weld cycles, estimated information about the weld area 65 generated from a weld area model, and the like.

In some embodiments, the feedback information and/or the secondary information 125 can be used during the weld cycle to vary the power intensity of the laser(s) 70. In some embodiments, the feedback information and/or the secondary information 125 can also be used during the weld cycle to terminate welding or to modify time periods throughout the weld cycle, as discussed below.

In some embodiments, the controller 90 can implement a dynamic power profile for each laser 70 during a weld cycle. The dynamic power profile includes at least one change in power intensity during the weld cycle. That is, the dynamic power profile varies the power intensity of the laser(s) 70 at least once between a first power intensity and a different, second power intensity.

For example, in a first general embodiment, the power of the laser(s) 70 is varied in a preset manner (e.g., set power intensities for set time periods). In this embodiment, the profile is not modified due to feedback during the weld cycle.

In a second general embodiment, the power of the laser(s) 70 is pulse width modulated in a preset manner. In this embodiment, the profile is not modified due to feedback during the weld cycle.

In a third general embodiment, the power of the laser(s) 70 is varied in a present manner. Power is modified or turned off due to input during the weld cycle, such as collapse distance. The input can include feedback from the weld area 65, stored information from previous weld cycles, an estimated or calculated value derived from other information, and the like.

In a fourth general embodiment, the power of the laser(s) 70 is partially or completely varied during the weld cycle due to a temperature input from the weld area 65.

In a fifth general embodiment, the power of the laser(s) 70 is varied as in the fourth general embodiment and/or with inputs of collapse distance, collapse velocity, rate of temperature change, uniformity of temperature, or the like, during the weld cycle.

In a sixth general embodiment, the power of the laser(s) 70 is varied as in the fifth general embodiment with inputs not from feedback during the weld cycle.

In a seventh general embodiment, the power of the laser(s) 70 is varied differently for different sections of the weld area 65.

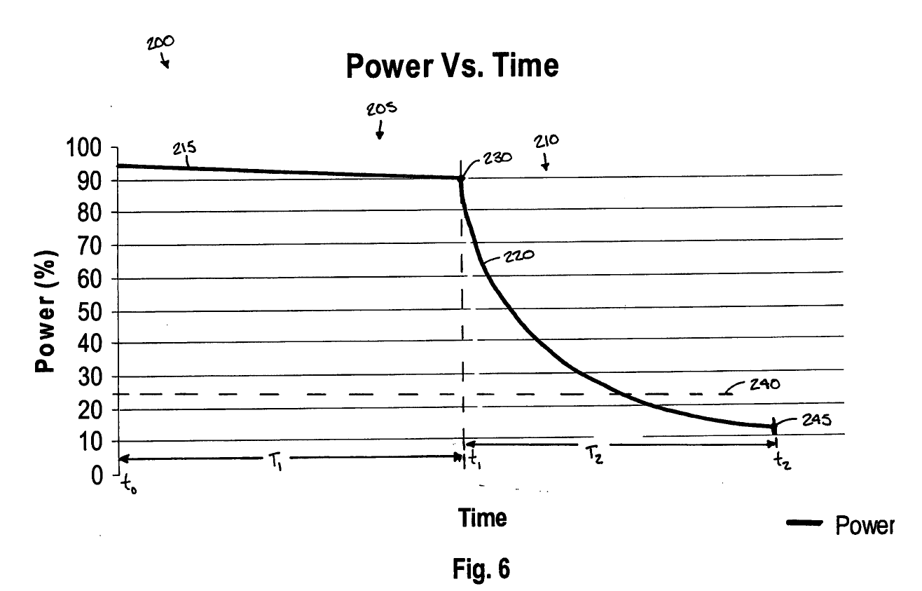

In an exemplary implementation illustrated in FIG. 6, the controller 90 utilizes temperature-based feedback (e.g., temperature, maximum temperature, average temperature, rate of temperature change, maximum rate of temperature change, average rate of temperature change, uniformity of temperature, temperature deviation and the like) for implementing and controlling a first dynamic power profile 200 during a weld cycle of welding a printhead 10. In this example, the dynamic power profile 200 includes a first portion 205 and a second portion 210. The first portion 205 includes the laser beam 75 being set at a constant power intensity 215 (e.g., approximately 95% of the maximum power intensity the lid 30 and printhead body 15 can receive). The second portion 210 includes a feedback-controlled varied power intensity 220. As illustrated, the varied power intensity 220 of the laser 70 is gradually reduced as the temperature of the weld area 65 approaches a set temperature point.

In this embodiment, the controller 70 receives temperature-based feedback (e.g., ) from the weld area 65 throughout the duration of the weld cycle, and compares the temperature data to certain thresholds. As illustrated in FIG. 6, the weld cycle begins with the controller 90 setting the laser beam 75 to a set or constant power intensity 215 (e.g., 95% intensity). Typically, the constant power intensity 215 of the laser(s) 70 is set to a high value near the full power inentsity, 100%, such as for example, approximately 85% to 100% intensity. In this embodiment, the high, constant power intensity 215 quickly raises the weld area temperature to a temperature within a desired temperature range, such as a softening temperature range (e.g., the range of temperatures in which the weld area 65 will soften), at a much faster rate than the standard, lower constant power intensity 300.

The temperature of the weld area 65 is raised to a temperature (e.g., a starting temperature) over a first period of time T₁. In some embodiments, the starting temperature includes a plurality of temperatures within a desired or set temperature range (e.g., the softening temperature range). In other embodiments, the starting temperature can include a specific temperature within the desired or set temperature range, such as, for example, the lower temperature limit or the higher temperature limit within the desired temperature range. In further embodiments, the starting temperature can include a desired or specific temperature point that may or may not be included in a desired temperature range. In this example, the starting temperature includes a plurality of temperatures within a desired or set temperature range, such as, for example, the softening temperature range. Also in this example, the temperature of the weld area 65 reaches the starting temperature (at point 230) at time t₁.

As shown in FIG. 6, the first portion 205 of the profile 200 concludes at the end of timer period T₁ (e.g., time t₁). Once the temperature reaches the starting temperature (e.g., one of the temperatures included in the softening temperature range), the varied power intensity 220 of the laser 70 included in the second portion 210 is gradually reduced during a second time period T₂ in order to maintain the temperature at the starting temperature (e.g., maintain the temperature within the desired temperature range). During this second time period T₂, the average power intensity 240 (shown in dashed lines) of the laser 70 supplied to the weld area 65 is less than the constant power intensity 215 delivered during the first time period T₁.

While the temperature is maintained at the starting temperature (e.g., at a temperature within the desired temperature range) (at point 245), the varied power intensity 220 has reached approximately zero, causing the weld cycle to be terminated at time t₂. In some embodiments, the varied power intensity 220 in the second portion 210 can inversely correlate to the weld area temperature. When implementing this exemplary power profile 200, the temperature of the weld area 65 is less likely to exceed any thresholds (such as, for example, a melting or bubbling threshold, or a temperature that is greater than the desired temperature range) and overheat. The weld area 65 is less likely to overheat, because the rate of temperature change in the weld area 65 gradually lowers as the varied power intensity 220 is reduced (and the weld area temperature is maintained within the desired temperature range).

In some embodiments, the temperature of the weld area 65 can be raised to a starting temperature (i.e., a first set temperature point) over a first period of time T₁. During the second time period, the temperature of the weld area 65 can be maintained at the starting temperature (i.e., the set temperature point) or can be gradually raised or lowered to an ending temperature (i.e., a second set temperature point). In one embodiment, for example, the second set temperature point can be greater than the first set temperature point, such that the weld area 65 is heated to a first temperature during the first time period T₁, and then gradually heated to a higher second temperature during the second time period T₂. In another embodiment, for example, the second set temperature point can be less than the first set temperature point, such that the weld area 65 is heated to a first temperature during the first time period T₁, and then gradually reduces to a lower second temperature point during the second time period T₂. In these embodiments, both the first set temperature point and the second set temperature point may be included within a softening temperature range.

As mentioned previously, in other embodiments, the weld area 65 can be heated to a starting temperature point (which may or may not include a range of temperatures) during the first time period T₁, and then can be maintained within a desired range of temperatures during the second time period T₂. In these embodiments, the temperature of the weld area 65 can be raised and/or lowered to one or more temperatures included in a range of temperatures during the second time period T₂. In some embodiments, the starting temperature point can include a first range of temperatures, and the desired range of temperatures can include a second range of temperatures. The first range can differ from the second range or can include the same temperatures as the second range. Furthermore, the second range can differ from the first range or can include the same temperatures as the first range.

Also in the exemplary implementation, the controller 90 can also receive collapse-based feedback (e.g., collapse distance, maximum collapse distance, average collapse distance, collapse velocity, maximum collapse velocity, average collapse velocity, and the like) to control and modify the varied power intensity 220 of the second portion 205. For example, a manipulating element 80 can apply pressure to the weld area 65 during the first time period T₁ and/or during the second time period T₂ to produce a desired collapse distance D. In one embodiment, the desired collapse distance D is at least approximately 0.1 mm. The controller 90 can terminate the welding cycle when the controller 90 determines that the desired collapse distance D between the two materials has been achieved.

In other variations of the dynamic power profile 200, the first portion 205 can include a first varied power intensity having a first average power intensity. The second portion 210 can then include either a second constant power intensity that is less than the first average power intensity, or can include a second varied power intensity having a second average power intensity that is less than the first average power intensity.

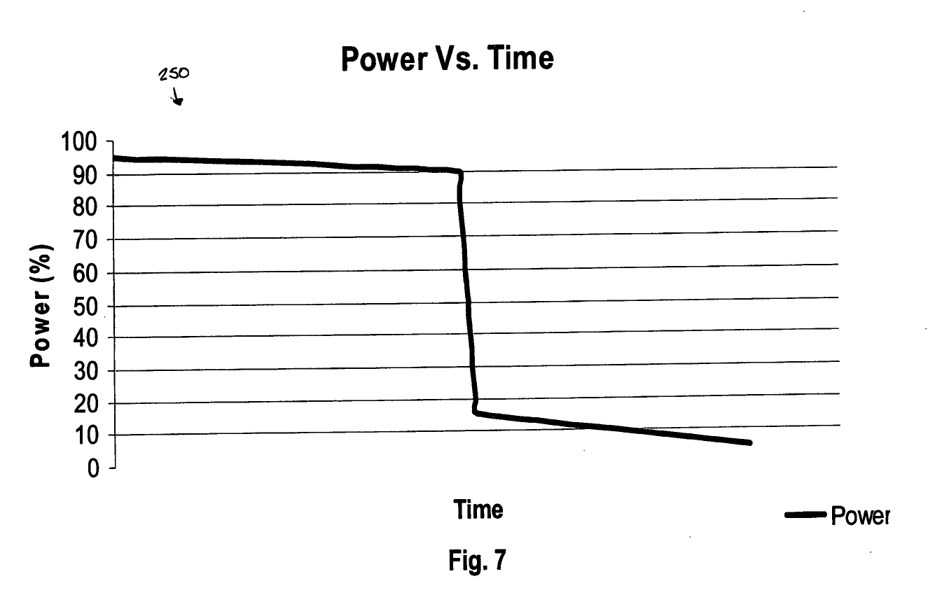

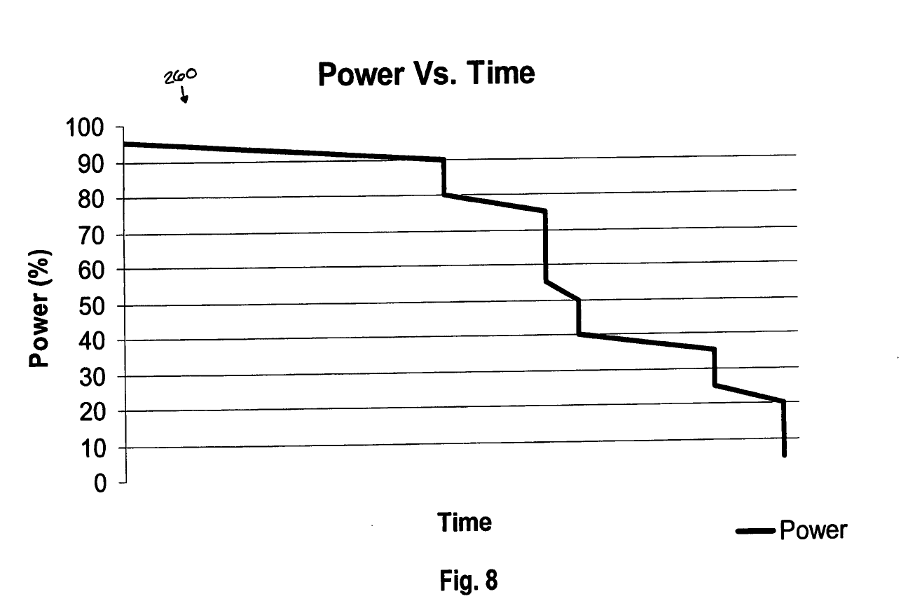

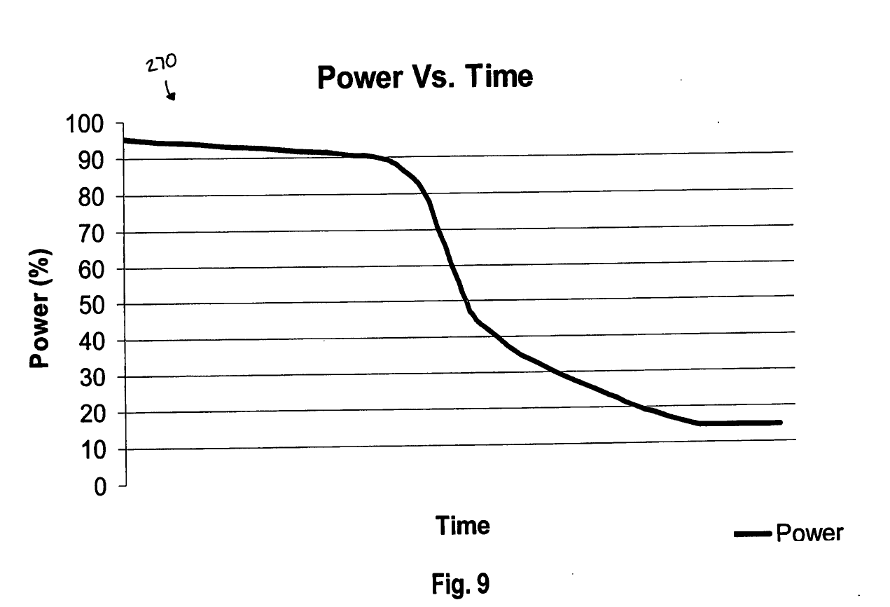

Other examples of the dynamic power profiles (and multiple power settings) that the controller 90 can establish during a laser welding cycle are illustrated in FIGS. 7-9. For example, the controller 90 can implement a single-step power profile 250 (illustrated in FIG. 7) with or without feedback control. The controller 90 can also implement a multi-step power profile 260 (illustrated in FIG. 8) with or without feedback control. The controller 90 can further implement a tapered power profile 270 (illustrated in FIG. 9) with or without feedback control, and the controller 90 can still further implement a ramped power profile (not shown) with or without feedback control, a combination of portions of the various dynamic profiles with or without feedback control, and the like.

An operator can determine which dynamic power profile (e.g., the power vs. time control) to implement during the weld cycle based on several factors. In one embodiment, when welding a printhead lid 30 to a printhead body 15, a certain dynamic power profile is selected or is created in order to 1) raise the temperature of both materials (e.g., the lid 30 and the body 15) of the weld area 65 to a softening temperature as fast as possible, typically starting at full-power intensity (e.g., 100% intensity), 2) maintain the weld interface temperature in an allowing range (such as the softening temperature range), 3) maintain the weld area temperature so both materials (e.g., the lid 30 and the body 15) are not degraded by overheating, 4) maintain the weld area temperature so it is not overheated causing low viscosity melted material (e.g., the lid 30 or the body 15) to move out of the weld area 65, and 5) maintain the weld area temperature for enough time so that adequate cohesion or adhesion can occur in the weld area 65.

In this embodiment, the factors are dependent of the characteristics of the different material types being welded, such as, for example, the softening temperature threshold, the softening temperature range, an overheating threshold, the temperature at which the material heats to a low viscosity, and the like. When welding a translucent material to a semi-crystalline material, for example, temperature-based feedback control can aid in the dynamic power profile due to the fact that semi-crystalline materials have a narrow softening temperature range which can produce reliable weld joints in the material.

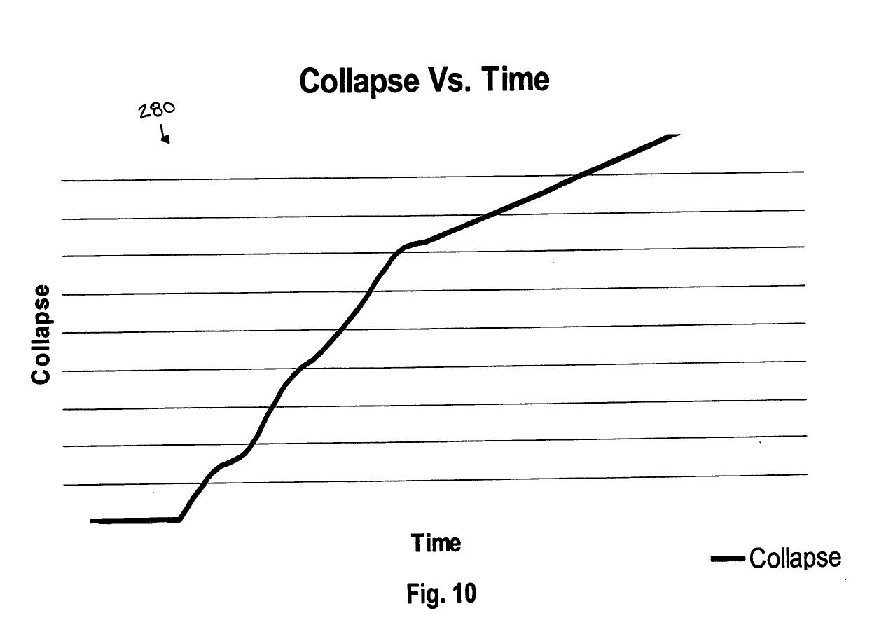

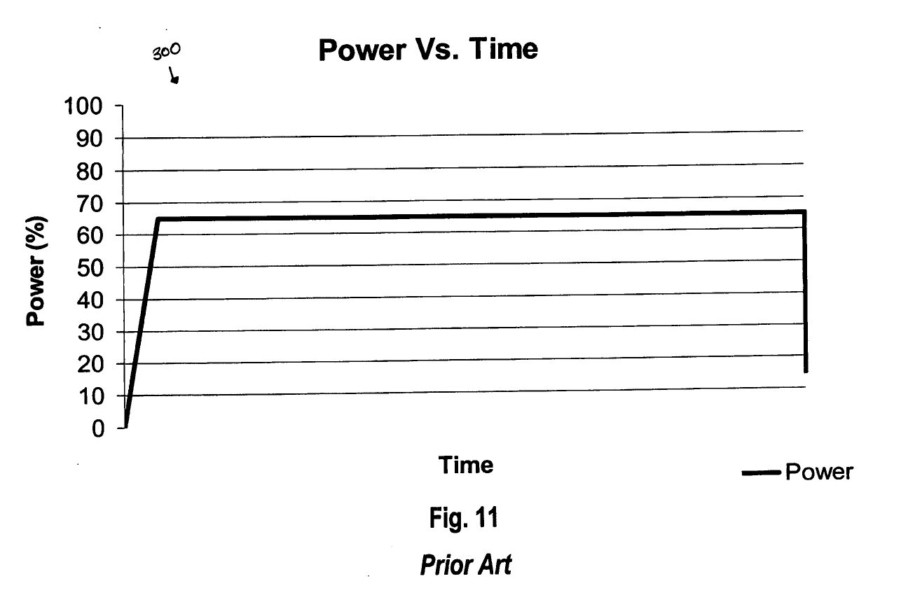

The various dynamic power profiles discussed above can also produce a more controlled collapse rate of the welded materials, as shown in FIG. 10. By controlling the power profile, the controller 90 can in turn control the rate at which the materials collapse, indicated by graph 280.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

1. A method of laser welding a first material of an apparatus to a second material of the apparatus, the second material including a semi-crystalline material and the first material and the second material forming a weld area, the method comprising:
heating a weld area with a first power intensity for one time period;
heating the weld area with a second power intensity for another time period, the second power intensity not being equal to the first power intensity; and
wherein the weld area is not heated using a contour welding method.

2. The method of laser welding as set forth in claim 1, and further comprising the acts of:
receiving feedback regarding the weld area during the one time period; and
heating the weld area with a second power intensity for the other time period based at least in part on the received feedback, the second power intensity not being equal to the first power intensity.

3. The method of laser welding as set forth in claim 2, and further comprising the acts of:
receiving second feedback regarding the weld area during the other time period; and
heating the weld area with a third power intensity for a further time period based at least in part on the second received feedback, the third power intensity not being equal to the first power intensity and not being equal to the second power intensity.

4. The method of laser welding as set forth in claim 3, and further comprising the acts of:
receiving feedback regarding the weld area during the one time period, the feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation; and
receiving second feedback regarding the weld area during the other time period, the second feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation.

5. The method of laser welding as set forth in claim 2, and further comprising the act of receiving feedback regarding the weld area during the one time period, the feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation.

6. The method of laser welding as set forth in claim 1, and wherein the first power intensity is a first constant power intensity and the second power intensity is a second constant power intensity not equal to the first constant intensity.

7. The method of laser welding as set forth in claim 1, and wherein the first power intensity is a first variable power intensity having a first average power intensity and the second power intensity is a second variable power intensity having a second average power intensity not equal to the first average power intensity.

8. The method of laser welding as set forth in claim 1, wherein the first power intensity is a first constant power intensity and the second power intensity is a second variable power intensity having a second average power intensity not equal to the first constant power intensity.

9. The method of laser welding as set forth in claim 1, wherein the first power intensity is a first variable power intensity having a first average power intensity and the second power intensity is a second constant power intensity not equal to the first average power intensity.

10. The method of laser welding as set forth in claim 1, and further comprising the act of heating the weld area with a third power intensity for a further time period, the third power intensity not being equal to the first power intensity and not being equal to the second power intensity.

11. A method of laser welding a first material of an apparatus to a second material of an apparatus, the first material and the second material forming a weld area, the method comprising:
heating a weld area with a first power intensity for one time period;
receiving feedback regarding the weld area during the one time period;
heating the weld area with a second power intensity for another time period, the second power intensity being based at least in part on the received feedback, the second power intensity not being equal to the first power intensity.

12. The method of welding as set forth in claim 11, and further comprising the acts of:
receiving feedback regarding the weld area during the other time period; and
heating the weld area with a third power intensity for a further time period, the third power intensity not being equal to the first power intensity and not being equal to the second power intensity.

13. The method of laser welding as set forth in claim 11, and further comprising the act of heating a weld area with a first power intensity for one time period, the first power intensity being a constant, approximately full-power power intensity and the one time period being dependent on the received feedback.

14. The method of laser welding as set forth in claim 13, and further comprising the act of heating the weld area with a second power intensity for another time period, the second power intensity being based at least in part on the received feedback and being a varied power intensity having a second average power intensity, the second average power intensity being less than the first power intensity.

15. The method of laser welding as set forth in claim 14, and further comprising the act of receiving temperature-based feedback regarding the weld area during the one time period.

16. The method of laser welding as set forth in claim 15, and further comprising the act of receiving both temperature-based feedback regarding the weld area during the one time period and collapse-based feedback regarding the weld area during the one time period.

17. A laser welding assembly for welding a first material of an apparatus to a second material of the apparatus during a weld cycle, the first material and the second material forming a weld area, the assembly comprising:
a laser source for producing a light beam operable to heat at least a portion of the weld area, the light beam having a power intensity and the laser source include a source input terminal; and
a controller having
an input terminal operable to receive a first signal, and
an output terminal coupled to the source input terminal and operable to transmit a second signal, the second signal including a command to vary the power intensity of the light beam during a weld cycle, the command based at least in part on the first signal.

18. The laser welding assembly as set forth in claim 17, and further comprising a manipulating element operable to manipulate the light beam.

19. The laser welding assembly as set forth in claim 18, and wherein the manipulating element includes at least one of a lens, a fiber optic cable, a wave guide, a mirror and a mask.

20. The laser welding assembly as set forth in claim 17, and wherein the first signal includes feedback information from the weld area during the weld cycle.

21. The laser welding assembly as set forth in claim 20, and wherein the first signal includes temperature-based feedback information from the weld area during the weld cycle.

22. The laser welding assembly as set forth in claim 21, and wherein the input terminal is operable to receive a third signal, the third signal includes collapse-based feedback information from the weld area during the weld cycle.

23. The laser welding assembly as set forth in claim 22, and wherein the output terminal is operable to transmit a termination command ending the weld cycle.

24. The laser welding assembly as set forth in claim 20, and wherein the first signal includes collapse-based feedback information from the weld area during the weld cycle.

25. A printhead assembly comprising:
a body portion, and
a lid portion welded to the body portion using a dynamic power profile during the laser welding process.

26. A printhead as set forth in claim 25, and wherein the printhead is an inkjet printhead.

27. A printhead as set forth in claim 26, and wherein the lid portion includes a substantially transparent material, and wherein the body portion includes a semi-crystalline material.

28. A printhead as set forth in claim 25, and wherein the at least a portion of the body portion and at least a portion of the lid portion define a weld area; and
wherein the dynamic power profile includes a first portion having a first power intensity being supplied to the weld area for one time period and a second portion having a second power intensity being supplied to the weld area for another time period subsequent to the one time period, the second power intensity being not equal to the first power intensity.

29. A printhead as set forth in claim 28, and wherein the second power intensity is less than the first power intensity.

30. A printhead as set forth in claim 28, and wherein the first power intensity is a first constant power intensity and the second power intensity is a second constant power intensity not equal to the first constant power intensity.

31. A printhead as set forth in claim 30, and wherein the second constant power intensity is less than the first constant power intensity.

32. A printhead as set forth in claim 31, and wherein the first constant power intensity is approximately a full-power intensity.

33. A printhead as set forth in claim 30, and wherein the second constant power intensity is based at least in part on feedback from the weld area during the other time period.

34. A printhead as set forth in claim 33, and wherein the feedback includes at least one of temperature-based feedback and collapse-based feedback.

35. A printhead as set forth in claim 28, and wherein the first power intensity is a first variable power intensity having a first average power intensity and the second power intensity is a second variable power intensity having a second average power intensity not equal to the first average power intensity.

36. A printhead as set forth in claim 35, and wherein the second average power intensity is less than the first average power intensity.

37. A printhead as set forth in claim 35, and wherein the second varied power intensity is based at least in part on feedback from the weld area during the other time period.

38. A printhead as set forth in claim 37, and wherein the feedback includes at least one of temperature-based feedback and collapse-based feedback.

39. A printhead as set forth in claim 28, and wherein the first power intensity is a first constant power intensity and the second power intensity is a second variable power intensity having a second average power intensity not equal to the first constant power intensity.

40. A printhead as set forth in claim 39, and wherein the second average power intensity is less than the first constant power intensity.

41. A printhead as set forth in claim 40, and wherein the first constant power intensity is approximately a full-power intensity.

42. A printhead as set forth in claim 39, and wherein the second varied power intensity is based at least in part on feedback from the weld area during the other time period.

43. A printhead as set forth in claim 42, and wherein the feedback includes at least one of temperature-based feedback and collapse-based feedback.

44. A printhead as set forth in claim 28, and wherein the first power intensity is a first variable power intensity having a first average power intensity and the second power intensity is a second constant power intensity not equal to the first average power intensity.

45. A printhead as set forth in claim 45, and wherein the second constant power intensity is less than the first average power intensity.

46. A printhead as set forth in claim 44, and wherein the second constant power intensity is based at least in part on feedback from the weld area during the other time period.

47. A printhead as set forth in claim 44, and wherein the feedback includes at least one of temperature-based feedback and collapse-based feedback.

48. A method of laser welding a first material of an apparatus to a second material of the apparatus, the second material including a semi-crystalline material and the first material and the second material forming a weld area, the method comprising:
heating a weld area with a first power intensity for one time period;
heating the weld area with a second power intensity for another time period, the second power intensity not being equal to the first power intensity; and
applying pressure to the weld area,
wherein a collapse distance is produced within at least a portion of the weld area.

49. The method of laser welding as set forth in claim 48, and further comprising the acts of:
receiving feedback regarding the weld area during the one time period; and
heating the weld area with a second power intensity for the other time period based at least in part on the received feedback, the second power intensity not being equal to the first power intensity.

50. The method of laser welding as set forth in claim 49, and further comprising the acts of:
receiving second feedback regarding the weld area during the other time period; and
heating the weld area with a third power intensity for a further time period based at least in part on the second received feedback, the third power intensity not being equal to the first power intensity and not being equal to the second power intensity.

51. The method of laser welding as set forth in claim 50, and further comprising the acts of:
receiving feedback regarding the weld area during the one time period, the feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation; and
receiving second feedback regarding the weld area during the other time period, the second feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation.

52. The method of laser welding as set forth in claim 49, and further comprising the act of receiving feedback regarding the weld area during the one time period, the feedback including at least one of collapse distance, maximum collapse distance, average collapse distance, collapse velocity, maximum collapse velocity, average collapse velocity, temperature, maximum temperature, average temperature, rate of temperature change, maximum rate of temperature change, average maximum rate of temperature change, uniformity of temperature throughout the weld area and temperature deviation.

53. The method of laser welding as set forth in claim 48, and wherein the first power intensity is a first constant power intensity and the second power intensity is a second constant power intensity not equal to the first constant intensity.

54. The method of laser welding as set forth in claim 48, and wherein the first power intensity is a first variable power intensity having a first average power intensity and the second power intensity is a second variable power intensity having a second average power intensity not equal to the first average power intensity.

55. The method of laser welding as set forth in claim 48, wherein the first power intensity is a first constant power intensity and the second power intensity is a second variable power intensity having a second average power intensity not equal to the first constant power intensity.

56. The method of laser welding as set forth in claim 48, wherein the first power intensity is a first variable power intensity having a first average power intensity and the second power intensity is a second constant power intensity not equal to the first average power intensity.

57. The method of laser welding as set forth in claim 48, and further comprising the act of heating the weld area with a third power intensity for a further time period, the third power intensity not being equal to the first power intensity and not being equal to the second power intensity.

58. The method of laser welding as set forth in claim 48, and wherein the collapse distance is at least approximately 0.1 mm.

59. The method of laser welding as set forth in claim 48, and further comprising the act of applying pressure to the weld area during the other time period.

60. The method of laser welding as set forth in claim 59, and further comprising the act of terminating the method of laser welding when the collapse distance exceeds approximately 0.1 mm.

61. The method of laser welding as set forth in claim 48, and further comprising the act of terminating the method of laser welding when the collapse distance exceeds approximately 0.1 mm.
